(19) United States
(12) Patent Application Publication
(10) Pub. No.: US 2006/0085136 A1
(43) Pub. Date: Apr. 20, 2006

(54) Method and system for determining an optimal amount of a pharmaceutical to be administered to a patient during surgery

(76) Inventor: Donald M. Mathews, Brooklyn, NY (US)

Correspondence Address: OSTROLENK FABER GERB & SOFFEN, 1180 AVENUE OF THE AMERICAS, NEW YORK, NY, 100368403, US

(21) Appl. No.: 11/252,649

(22) Filed: Oct. 18, 2005

Related U.S. Application Data
(60) Provisional application No. 60/620,508, filed on Oct. 20, 2004.

(51) Int. Cl. G06F 19/00; G06Q 50/00

(52) U.S. Cl. 702/19; 702/27; 705/3

(57) ABSTRACT

A method for determining an optimal amount of a pharmaceutical to be administered to a patient during surgery in accordance with an embodiment of the present application includes establishing a desired effect-site concentration of the pharmaceutical, infusing a proper amount of the pharmaceutical into the patient based on the desired effect-site concentration, monitoring the patient to collect data regarding at least one parameter of a plurality of parameters related to the patient and analyzing the collected data to determine whether to alter the desired effect-site concentration. The desired effect site concentration may be altered in the establishing step based on the analysis of the data regarding the at least one parameter of the plurality of parameters in the analyzing step in the context of the level of surgical stimulation indicated by the caregiver. A system for determining an optimal amount of a pharmaceutical to be administered to a patient in accordance with an embodiment of the present application includes a concentration establishing device adapted to establish a desired effect-site concentration of the pharmaceutical, an infusing device adapted to infuse a proper amount of pharmaceutical into the patient based on the desired effect-site concentration, a monitor adapted to monitor the patient to collect data regarding at least one parameter of a plurality of parameters related to the patient and an analyzing device adapted to analyze the collected data to determine whether to alter the desired effect-site concentration.

### REFERENCE TO RELATED APPLICATIONS

The present application claims the benefit of Provisional Application Ser. No. 60/620,508 filed Oct. 20, 2004, the entire contents of which are herein incorporated by reference.

### BACKGROUND

1. Field of the Invention

The present application relates to a method and system for determining an optimal amount of a pharmaceutical, such as an opiate, to be administered to a patient during surgery. The method and system of the present application use feedback information gathered by monitoring the patient to determine the amount of the pharmaceutical administered to the patient.

2. Brief Description of Related Art

Determining the proper dosage of a pharmaceutical to be administered to a patient is an important and yet sometimes difficult task. This is especially true when a patient is undergoing surgery. The invasive nature of surgery and the constantly changing levels of activity around the patient during the surgery add factors that should be considered when administering a pharmaceutical during surgery. Over the course of a surgery, which in some cases may last several hours, various factors that effect how a particular pharmaceutical effects the patient may change. For example, where the pharmaceutical is an opiate, for example, which is typically used to control pain, the surgery itself may include different stages in which the patient's body subjected to more or less trauma. Naturally, the proper dosage of the opiate to compensate for this trauma may vary depending on the particular stage of the surgery. Other factors also come into play, including ensuring that a patient's heartbeat, blood pressure and respiration remain normal throughout the surgery.

Thus, it would be advantageous to provide a method of determining the optimal amount of a pharmaceutical to be administered to a patient during surgery that addresses the concerns discussed above.

### SUMMARY OF THE INVENTION

A method for determining an optimal amount of a pharmaceutical to be administered to a patient during surgery in accordance with an embodiment of the present application includes establishing a desired effect-site concentration of the pharmaceutical, infusing a proper amount of the pharmaceutical to the patient based on the desired effect-site concentration, monitoring the patient to collect data regarding at least one parameter of a plurality of parameters related to the patient and analyzing the data collected in the monitoring step to determine whether to alter the desired effect-site concentration.

A system for determining an optimal amount of a pharmaceutical to be administered to a patient during surgery in accordance with an embodiment of the present application includes a concentration establishing device adapted to establish a desired effect-site concentration of the pharmaceutical, an infusing device adapted to infuse a proper amount of pharmaceutical into the patient based on the desired effect-site concentration, a monitor adapted to monitor the patient to collect data regarding at least one parameter of a plurality of parameters related to the patient and an analyzing device adapted to analyze the collected data to determine whether to alter the desired effect-site concentration.

Other features and advantages of the present invention will become apparent from the following description of the invention which refers to the accompanying drawings.

### BRIEF DESCRIPTION OF THE DRAWING(S)

FIG. 1 is a flow chart illustrating a method for determining an optimal amount of a pharmaceutical to be administered to a patient during surgery according to an embodiment of the present application;

FIG. 2 is a flow chart illustrating a step of analyzing data gathered in a monitoring step of the method of FIG. 1 according to an embodiment of the present application;

FIG. 3 is a flow chart illustrating a method for determining whether to increase the desired effect-site concentration of the pharmaceutical according to an embodiment of the present application;

FIG. 4 is a flow chart illustrating a method for determining whether to decrease the desired effect-site concentration of the pharmaceutical according to an embodiment of the present application; and

FIG. 5 is a block diagram illustrating system for determining an optimal amount of a pharmaceutical to be administered to a patient during surgery according to an embodiment of the present application.

### DETAILED DESCRIPTION OF PREFERRED EMBODIMENTS OF THE INVENTION

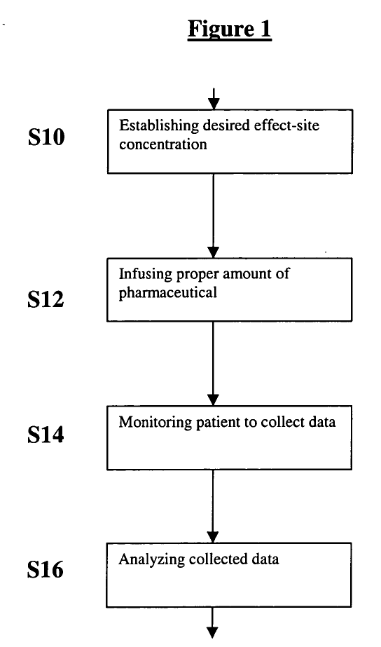

A method for determining the optimal amount of a pharmaceutical to be administered to a patient during surgery in accordance with an embodiment of the present application is described in further detail with reference to FIG. 1.

In step S10, a desired effect-site concentration of the pharmaceutical is established. Thereafter, at step S12 the proper amount of pharmaceutical is infused into the patient based on the desired effect-site concentration. At step S14, the patient is monitored to collect data regarding a plurality of parameters related to the patient. In step S16, the data collected in the monitoring step is analyzed to determine whether to alter the desired effect-site concentration.

For convenience, the method of the present application is described in detail below using an opiate as the pharmaceutical to be administered to the patient, however, the method and system of the present application may be used to administer most any pharmaceutical substance.

In step S10, the desired effect-site concentration of the pharmaceutical is established. As noted above, in the particular embodiment discussed below, the pharmaceutical is an opiate. Thus, to be more precise, in step S10, the desired effect-site opiate concentration (ESOC) may be established. The terms effect-site concentration and effect site opiate concentration (ESOC) are used interchangably herein since the ESOC is simply one particular effect site concentration for an opiate. Initially, the desired ESOC may be input by a care giver, preferably based on pharmacokinetic models such as STANPUMP, for example. Alternatively, the initial desired effect-site concentration may be automatically provided based on a pharmacokinetic model stored in a memory, for example. However, any medically acceptable means for determining the initial desired effect-site opiate concentration may be used. In addition, the care giver preferably inputs other information useful in establishing the desired ESOC. For example, the care giver preferably provides surgical stimulus information to indicate whether the level of surgical stimulus will increase, decrease, remain the same or be none. Where the surgical stimulus is none, the surgery will continue, however, surgical stimulation is temporarily suspended, for example, when an intraoperative X-ray is taken. If increased surgical stimulus is expected, it may be desirable to increase the desired ESOC. Similarly, if decreased surgical stimulus is expected, it may be desirable to decrease the desired ESOC. The desired ESOC may also be established or altered based on results of the analyzing performed in step S16, which will be discussed in further detail below. The information entered by the care giver is preferably provided through an input device, such as a keyboard or mouse, for example, in a computer system. The care giver may also provide one or more threshold values used in the analyzing step S16 as discussed below. Alternatively, the threshold value may be automatically determined based on the surgical stimulation information provided by the user.

Once the desired ESOC is established, at S12, the proper amount of opiate, or other pharmaceutical, is infused into the patient based on the desired effect-site concentration. This step may be implemented utilizing a computer controlled infusion pump, for example, with the computer determining the proper infusion rates for the pump based on the desired ESOC and then instructing the pumps to infuse the proper amount of opiate. However, any appropriate means for infusing the opiate into the patient may be utilized.

At step S14, the patient is monitored to collect data regarding at least one parameter of a plurality of parameters related to the patient. The plurality of parameters may include, but is not limited to: patient heart rate, blood pressure, respiratory rate, chest wall compliance, height of area under plethysmography wave, pulse transit time, Bispectral Index (BIS, Aspect Medical Systems, Newton, Mass.), variation in BIS over time, facial electromyographic EMG data from the BIS or another monitor, and the State Entropy, Response Entropy or gradient therebetween (M-Entropy monitor, Datex-Ohmeda, Helsinki). The plurality of parameters may include one of or some combination of any of these parameters or some combination of these and/or any other physiologic or electrophysiologic functions of the patient. The data regarding these parameters is preferably collected utilizing one or more electronic monitoring devices that are well known in the art.

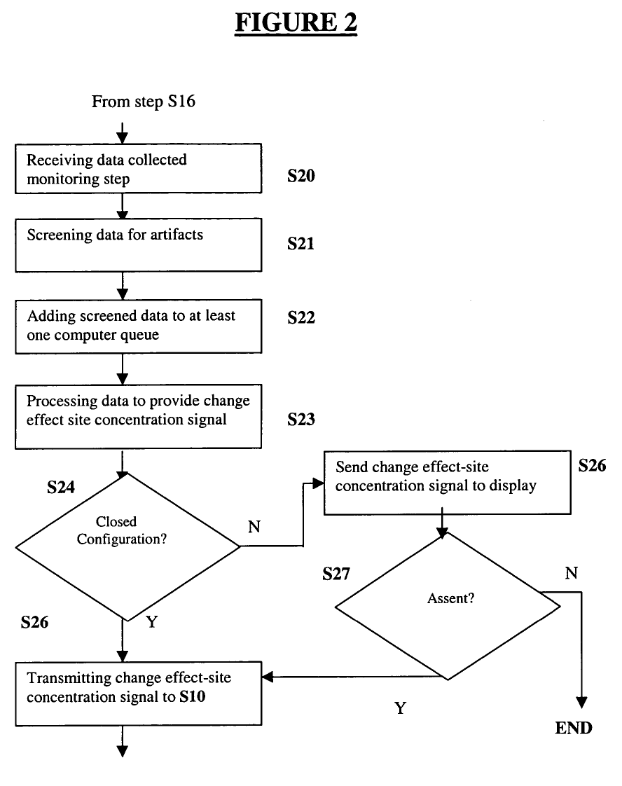

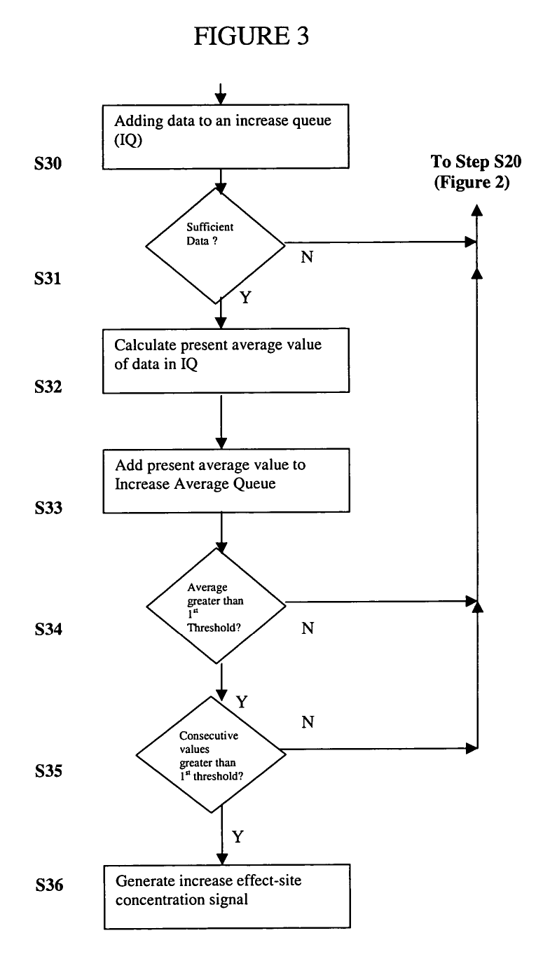

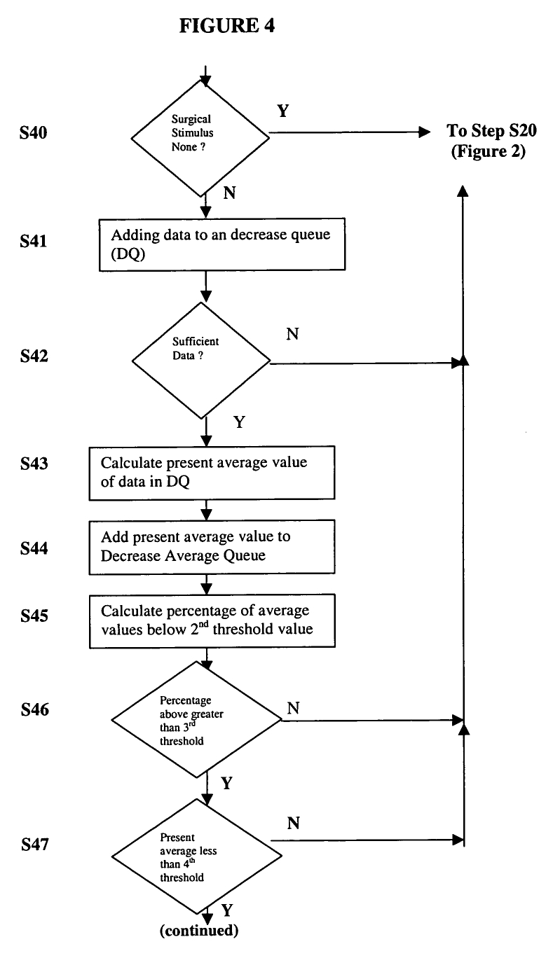

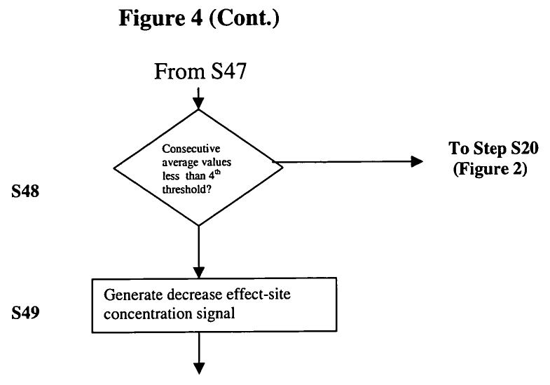

At step S16, the data that is collected in step S14 is analyzed to determine whether to alter the desired ESOC. The analyzing step S16 is discussed in further detail with reference to FIG. 2. In step S20, data collected in the monitoring step S14 is received. In addition, any surgical stimulus information provided in the establishing step S10 may also be received or retrieved for use in the analyzing step S16. At step S21, the received data is screened to determine whether it includes any artifacts attributable to the various electronic monitoring devices noted above. If so (Y at step S21), the data is ignored and the process returns to step S20 to wait for more data. If not (N at step S21), at step S22, the data is added to at least one computer queue to be processed. The queue is preferably a computer queue that data may be temporarily stored in to await further analysis. In a preferred embodiment of the present application, data may be added to both an increase queue (IQ) and a decrease queue (DQ). However, a single computer queue may be used. In step S23, the data in the queue is processed to provide a change effect-site concentration signal. In a preferred embodiment, data in the IQ is processed to determine whether the desired effect-site concentration is to be increased and data in the DQ is processed to determine whether the desired ESOC is to be decreased. The processing of the data in the IQ and the DQ will be discussed in further detail below. At step S24, a determination is made as to whether the method is being operated in a “closed” configuration. If so (Y at S24), the change effect-site concentration signal is returned to step S10 of FIG. 1 to be used in establishing or altering the desired effect-site concentration of the pharmaceutical. If not (N at step S24), at step S25, the change effect-site concentration signal is provided to a display (not shown) where a recommendation based on the change effect-site concentration signal is generated and displayed to the care giver. At step S26, a determination is made as to whether the care giver assents to the recommendation of changing the desired effect-site concentration. If so, (Y at step S26) the change effect-site concentration signal is returned to step S10 of FIG. 1 to be used in establishing the desired effect-site concentration. Otherwise (N at step S26), the process may end. However, it is noted that the care give may still manually alter the desired effect-site concentration via the input device as described in step S10 of FIG. 1. The care giver may follow the recommendation provided based on the change effect-site concentration signal or may ignore the recommendation. Thus, when in a “closed” configuration the method of the present application will automatically establish the effect-site concentration based on the analysis in step S16 of the data gathered during monitoring step S14. When in an “open” configuration, the care giver is required to assent to the recommendation provided based on the change effect-site concentration signal provided by the analysis in the analyzing step S14 of the data collected in the monitoring step S16. Thus, in the “open” configuration, outside influence, such as the assent of the care giver is necessary to alter the desired effect-site concentration. Alternatively, the method may be configured in a “hybrid” configuration in which certain changes are automatically made in the establishing step S10 based on the change effect-site concentration signal, while other require assent from the care giver. For example, where the change effect-site change signal recommends a decrease in the desired effect-site concentration, the establishing step may automatically decrease the desired effect-site concentration, while an increase in the desired effect-site concentration requires assent from the care giver. In the alternative, a decrease in desired effect-site concentration may require assent while an increase of the desired effect-site concentration may be automatic.

The processing of the data in the IQ is described in further detail with regard to FIG. 3. At step S30, the screened data is added to the IQ. At step S31, a determination is made as to whether there is sufficient data in the IQ to proceed. That is, whether there is enough data in the IQ to make a reliable determination of whether to alter the ESOC. If not (N at step S31), the data is ignored and the method returns to step S20 to wait for another piece of data. If so (Y at S 31), at step S32, a present average value of the data in the IQ is calculated. At step S33, the present average value is added to an Increase Average Queue (IAQ). In step S34, a determination is made as to whether the present average value is greater than a first threshold value. If not (N, at step S34), the method returns to step S20 to await more data. If so (Y at step S34), at step S35, a determination is made as to whether consecutive average values in the IAQ have been greater than the first threshold. If not (N at step S35), the method returns to step S20 to await further data. If so (Y at step S 35), at step S36, an increase effect-site concentration signal may be generated to indicate that the desired effect-site concentration should be increased. The amount of the increase recommended by the increase effect site concentration signal may be based on the number of consecutive average values that are greater than the first threshold. That is, when there are two consecutive average values that are greater than the first threshold, an increase of X is recommended, but, where three consecutive average values are greater than the first threshold value, a greater increase is recommended. The increase effect-site concentration signal may be the change effect-site signal discussed above with reference to FIG. 2.

The processing of data in the DQ is described in further detail with regard to FIG. 4. At step S40, before the data is actually added to the DQ a determination is made as to whether the surgical stimulus information is “none.” If so (Y at step S40), the data is ignored and the process returns to step S20 to wait for additional information. That is, if the surgical stimulus information provided by the care give is none, there will be no decrease of the ESOC. If not (N at step S40), the data is added to the DQ at step S41. At step S42, a determination is made as to whether there is sufficient data in the DQ to proceed. If not (N at step S42), the data is ignored and the process returns to step S20 to wait for more data. If so (Y at S 41), at step S43, a present average value of the data in the DQ is determined. At step S44, the present average value of the data in the DQ is added to a Decrease Average Queue( DAQ). In step S45, the percentage of average values in the DAQ that are below a second predetermined threshold value is calculated. At step S46, a determination is made as to whether this percentage is greater than a third predetermined threshold value. If not (N at step S46), the data is ignored and the process returns to step S20 to wait for additional data. If so (Y at step S46), at step S47, a determination is made as to whether the present average value last entered into the DAQ is less than a fourth predetermined threshold value. In not (N at step S47) the data is ignored and the process returns to step S20 to wait for additional data. If so (Y at step S47), at step S48, a determination is made as to whether consecutive average values added to the DAQ have been below the fourth predetermined threshold. If not, (N, at step S48) the process returns to step S20 to await more data. If so (Y at step S48), at step S49 a decrease effect-site concentration signal is provided. The amount of the decrease recommended by the decrease effect-site concentration signal may be based on the number of consecutive average values that are less than the fourth threshold. That is, when there are two consecutive average values that are less than the fourth threshold, an decrease of Y is recommended, but, where three consecutive average values are less than the fourth threshold value, a greater decrease is recommended. The decrease effect-site concentration signal may be the change effect-site concentration signal discussed above with reference to FIG. 2.

Generally, the desired effect-site concentration will remain the same unless the change effect-site concentration signal indicates that a change is recommended. In the event that both an increase effect-site concentration signal and a decrease effect-site concentration signal are both generated, the increase effect-site concentration signal is preferred. In a preferred embodiment a “lock out” period may be implemented following either an increase or decrease of the desired effect site concentration. Preferably, after an increase, there will be a predetermined period of time during which no further increase of the desired effect site concentration will be accepted and a second predetermined period of time during which no decrease of the desired effect site concentration will be accepted. Similarly, following a decrease in the desired effect site concentration, there will be a third predetermined period of time during which no further decrease of the desired effect site concentration will be accepted and a fourth predetermined period of time during which no increase of the desired effect site concentration will be allowed.

As noted above, the method of the present application may be utilized to determine the proper dosage of most any pharmaceutical administered to a patient during surgery. For example, the pharmaceutical may be a hypnotic in which case an effect-site hypnotic concentration is established in step S10 for example.

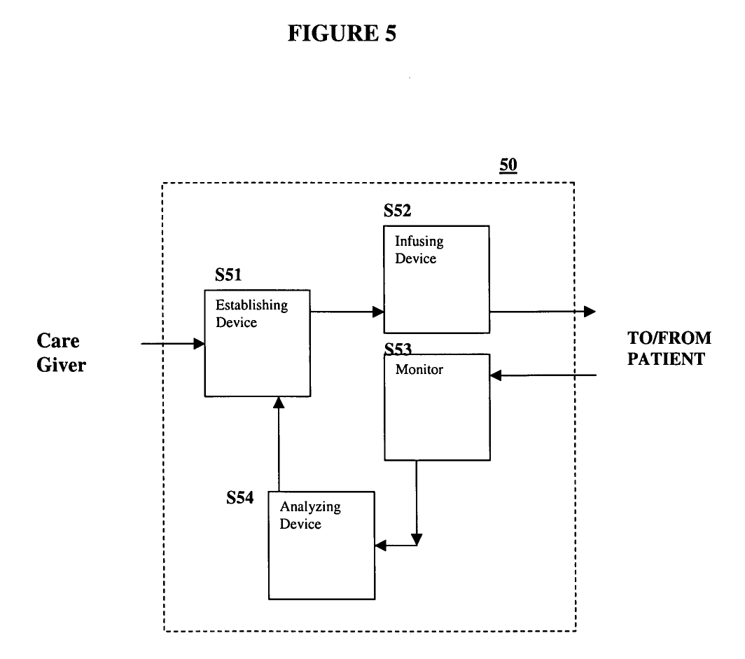

A system 50 for determining an optimal amount of a pharmaceutical to be administered to a patient during surgery is described in further detail with reference to FIG. 5.

A concentration establishing device 51 is used to establish a desired effect-site concentration of the pharmaceutical. An infusing device 52 infuses a proper amount of pharmaceutical into the patient based on the desired effect-site concentration. A monitor S53 is provided to monitor the patient to collect data regarding a plurality of parameters related to the patient. An analyzing device S54 analyzes the collected data to determine whether to alter the desired effect-site concentration.

The system of FIG. 5 substantially implements the method described above with reference to FIGS. 1-4 and thus will not be discussed in further detail herein.

The method and system of the present application may be conveniently implemented using one or more conventional general purpose digital computers and/or servers programmed according to the teachings of the present specification. Appropriate software coding can readily be prepared by skilled programmers based on the teaching is of the present disclosure. The present disclosure may also be implemented by the preparation of application specific integrated circuits or by interconnecting an appropriate network of conventional components.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for determining an optimal amount of a pharmaceutical to be administered to a patient during surgery comprising:
establishing a desired effect-site concentration of the pharmaceutical;
infusing a proper amount of the pharmaceutical into the patient based on the desired effect-site concentration;
monitoring the patient to collect data regarding at least one parameter of a plurality of parameters related to the patient; and
analyzing the collected data to determine whether to alter the desired effect-site concentration.

2. The method of claim 1, wherein the establishing step further comprises:
receiving the desired effect-site concentration from a care giver via an input device.

3. The method of claim 1, wherein the establishing step further comprises receiving surgical stimulus information from a care giver via an input device, wherein the surgical stimulus information indicates at least one of an increase in surgical stimulation, a decrease in surgical stimulation, maintaining a present level of surgical stimulation and no surgical stimulation; and
establishing the desired effect-site concentration at least in part based on the surgical stimulation information.

4. The method of claim 1, wherein the step of establishing the desired effect-site concentration includes receiving a change effect-site concentration signal based on a result of the analyzing step, wherein the desired effect-site concentration is altered based on the change effect-site concentration signal.

5. The method of claim 1, wherein the infusing step further comprises:
automatically determining an injection flow rate for the pharmaceutical based on the desired effect-site concentration and infusing the pharmaceutical at the determined flow rate.

6. The method of claim 1, wherein the plurality of parameters related to the patient includes at least one of physiological functions of the patient and electrophysiological functions of the patient.

7. The method of claim 1, wherein the data regarding the at least one parameter of the plurality of parameters that is collected in the monitoring step is collected by at least one electronic monitoring device.

8. The method of claim 7, wherein the analyzing step further comprises:
receiving the data collected in the monitoring step;
screening the data for artifacts added to the data by the at least one monitoring device;
adding the screened data to at least one computer queue;
processing the data in the at least one computer queue to provide a change effect-site concentration signal;
determining whether the method is in a closed configuration; and
providing the change effect-site concentration signal to the establishing step when the method is in the closed configuration.

9. The method of claim 8, wherein the analyzing step further comprises:
proving the change effect-site concentration signal to a display device when the method is not in a closed configuration;
displaying a recommendation to a care giver based on the change effect-site concentration signal;
determining whether the care giver assents to the recommendation; and
providing the change effect-site concentration signal to the establishing step when the care giver assents to the recommendation.

10. The method of claim 9, wherein the processing step further comprises:
adding the received data to an increase queue;
determining whether there is sufficient data in the increase queue to proceed;
calculating a present average value for the data in the increase queue when there is sufficient data in the increase queue to proceed;
adding the present average value to an increase average queue;
determining whether the present average value is greater than a first threshold value;
determining whether consecutive average values in the increase average queue are above the first threshold, when the present average value is above the first threshold value; and
generating an increase effect-site concentration signal when consecutive average values in the increase average queue are above the first threshold value, wherein an amount of increase recommended by the increase effect site concentration signal is based on a number of consecutive average values in the increase average queue that are above the first predetermined threshold.

11. The method of claim 9, wherein the processing step further comprises:
determining whether a surgical stimulation status is none;
adding the received data to a decrease queue when the surgical stimulation status is not none;
determining whether there is a sufficient amount of data in the decrease queue to proceed;
calculating a present average value of the data in the decrease queue when there is a sufficient amount of data in the decrease queue to proceed;
adding the present average value to a decrease average queue;
computing a percentage of average values in the decrease average queue that are below a second threshold value;
determining whether the percentage of average values in the decrease average queue that are below the second threshold level is above a third threshold value;
determining whether the present average value is below a fourth threshold value when the percentage of average values in the decrease average queue that are below the second threshold level is above the third threshold value;
determining whether consecutive average values in the decrease average queue are below the fourth threshold value when the present average value is below the fourth threshold value; and
generating a decrease effect-site concentration signal when consecutive average values in the decrease average queue are above the fourth threshold, wherein an amount of decrease recommended by the decrease effect site concentration signal is based on a number of consecutive average values in the decrease average queue that are below the fourth predetermined threshold.

12. A system for determining an optimal amount of a pharmaceutical to be administered to a patient during surgery comprising:
a concentration establishing device adapted to establish a desired effect-site concentration of the pharmaceutical;
an infusing device adapted to infuse a proper amount of pharmaceutical into the patient based on the desired effect-site concentration;
a monitor adapted to monitor the patient to collect data regarding at least one parameter of a plurality of parameters related to the patient; and
an analyzing device adapted to analyze the collected data to determine whether to alter the desired effect-site concentration.

13. The system of claim 12, wherein the concentration establishing device receives the desired effect-site concentration from a care giver via an input device.

14. The system of claim 12, wherein the concentration establishing device receives surgical stimulus information from a care giver via an input device, wherein the surgical stimulus information indicates at least one of an increase in surgical stimulation, a decrease in surgical stimulation, maintaining a present level of surgical stimulation or no surgical stimulation and wherein the concentration establishing device established the desired effect site concentration based at least in part on the surgical stimulation information.

15. The system of claim 12, wherein the concentration establishing device receives a change effect-site concentration signal based on a result of analysis in the analyzing device, wherein the desired effect-site concentration is altered based on the change effect-site concentration signal.

16. The system of claim 12, wherein the infusing device further comprises:
a controller that automatically determines an injection flow rate for the pharmaceutical based on the desired effect-site concentration electronically; and
at least one infusion pump adapted to infuse the pharmaceutical at the determined flow rate.

17. The system of claim 12, wherein the plurality of parameters related to the patient include at least one of physiological functions of the patient and electrophysiological functions of the patient.

19. The system of claim 12, wherein the data regarding the at least one parameter of the plurality of parameters that is collected by the monitor is collected by at least one electronic monitoring device.

20. The method of claim 19, wherein the analyzing device further comprises:
a receiving device adapted to receive data collected in the monitoring step;
a screening device adapted to screen the data for artifacts added to the data by the at least one electronic monitoring device;
at least one computer queue to which the data is added;
a processor adapted to process the data in the at least one computer queue to provide a change effect-site concentration signal;
a configuration device adapted to determine whether the method is in a closed configuration; and
a transmitting device adapted to transmit the change effect-site concentration signal to the concentration establishing device when the method is in the closed configuration.

21. The system of claim 20, further comprising:
a display adapted to display information to a care giver that receives the change effect-site concentration signal when the system is not in a closed configuration;
a recommendation device adapted to generate a recommendation based on the change effect-site concentration to be displayed to the care giver on the display;
an assent controller adapted to determining whether the care giver assents to the recommendation; wherein the change effect-site concentration signal is transmitted to the establishing step when the care giver assents to the recommendation.

22. The system of claim 20, wherein the processor further comprises:
an increase queue to which the received data is added;
a first determining device adapted to determine whether there is sufficient data in the increase queue to proceed;
a first calculating device adapted to calculate a present average value for the data in the increase queue when there is sufficient data to proceed;
an increase average queue to which the present average value is added;
a second determining device adapted to determine whether the present average value is greater than a first threshold value;
a third determining device adapted to determine whether consecutive average values in the increase average queue are above the first threshold value, when the present average value is above the first threshold value; and
an increase signal generating device adapted to generate an increase effect-site concentration signal when consecutive average values in the increase average queue are above the first threshold, wherein an amount of increase recommended by the increase effect site concentration signal is based on a number of consecutive average values in the decrease average queue that are above the first predetermined threshold.

23. The system of claim 20, wherein the processor further comprises:
a status device adapted to determine whether a surgical stimulation status is none;
a decrease queue to which the received data is added when the surgical stimulation status is not none;
a first determining device adapted to determine whether there is a sufficient amount of data in the decrease queue to proceed;
a first calculating device adapted to calculate a present average value of the data in the decrease queue when there is sufficient data in the decrease queue to proceed;
a decrease average queue to which the present average value is added;
a second calculating device adapted to calculate a percentage of average values in the decrease average queue that are below a second threshold value;
a second determining device adapted to determine whether the percentage of average values in the decrease average queue that are below the second threshold level is above a third threshold value;
a third determining device adapted to determine whether the present average value is below a fourth threshold value when the percentage of average values in the decrease average queue that are below the second threshold level is above the third threshold value;
a fourth determining device adapted to determine whether consecutive average values in the decrease average queue are below the fourth threshold value when the present average DQ value is below the fourth threshold value; and
a change signal generating device adapted to generate a decrease effect-site concentration signal when consecutive average values in the decrease average queue are above the fourth threshold, wherein an amount of decrease recommended by the decrease effect site concentration signal is based on a number of consecutive average values in the decrease average queue that are below the fourth predetermined threshold.

24. A method for determining an optimal amount of a pharmaceutical to be administered to a patient during surgery comprising:
establishing a desired effect-site concentration of the pharmaceutical, wherein the desired effect site concentration of the pharmaceutical is based on surgical stimulus information from a care giver provided via an input device, wherein the surgical stimulus information indicates at least one of an increase in surgical stimulation, a decrease in surgical stimulation, maintaining a present level of surgical stimulation and no surgical stimulation;
infusing a proper amount of the pharmaceutical into the patient based on the desired effect-site concentration;
monitoring the patient to collect data regarding at least one parameter of a plurality of parameters related to the patient; and
analyzing the collected data to determine whether to alter the desired effect-site concentration.
